(19) United States
(12) Patent Application Publication
(10) Pub. No.: US 2022/0146042 A1
(43) Pub. Date: May 12, 2022

(54) HANDHELD GIMBAL

(71) Applicant: SZ DJI TECHNOLOGY CO., LTD., Shenzhen (CN)

(72) Inventor: Tianfei ZHAO, Shenzhen (CN)

(73) Assignee: SZ DJI TECHNOLOGY CO., LTD., Shenzhen (CN)

(21) Appl. No.: 17/586,795

(22) Filed: Jan. 28, 2022

Related U.S. Application Data
(63) Continuation of application No. PCT/CN2019/098517, filed on Jul. 31, 2019.

(51) Int. Cl. F16M 13/04; F16M 11/18; F16M 11/20; F16M 11/10; F16M 11/04; G03B 17/56

(52) U.S. Cl. CPC F16M 13/04; F16M 11/18; F16M 11/2064; G03B 17/563; F16M 11/041; G03B 17/561; F16M 11/105

(57) ABSTRACT

A handheld gimbal. The handheld gimbal may include a handle; a first shaft assembly including a first rotating shaft, a first shaft motor for driving the first rotating shaft, and a first connecting arm connected with the first rotating shaft; a second shaft assembly including a second rotating shaft, a second shaft motor for driving the second rotating shaft, and a second connecting arm connected to the second rotating shaft; a third shaft assembly including a third rotating shaft and a third shaft motor for driving the third rotating shaft; and a bearing portion connected with the third shaft assembly and configured to carry a shooting equipment. When the handheld gimbal is changed from the usage state to a storage state, the second shaft motor may be configured to provide driving force to rotate the second connecting arm to fold the handheld gimbal.

### CROSS REFERENCE TO RELATED DISCLOSURE

The present disclosure is a continuation of International Disclosure No. PCT/CN2019/098517, filed Jul. 31, 2019, the entire contents of which being incorporated herein by reference in its entirety.

### TECHNICAL FIELD

The present disclosure relates to the field of a gimbal device, and specifically relates to a handheld gimbal.

### BACKGROUND

Taking pictures and photography with mobile phones has become a popular hobby. In order to be able to shoot stable and smooth images, it is often necessary to use a handheld gimbal. In a traditional foldable gimbal, in addition to a necessary stabilization axis, an additional folding shaft is required to switch the gimbal from an unfolded state to a folded, storage state. The externally arranged folding shaft increases overall volume of the handheld gimbal, increases weight of the handheld gimbal, and also has a certain negative impact on reliability and stability of the gimbal.

### SUMMARY

One example of the present disclosure provides a handheld gimbal. The handheld gimbal may include a handle having a top, a bottom, and a side wall between the top and the bottom; a first shaft assembly including a first rotating shaft provided at the top of the handle, a first shaft motor for driving the first rotating shaft, and a first connecting arm connected with the first rotating shaft; a second shaft assembly including a second rotating shaft, a second shaft motor for driving the second rotating shaft, and a second connecting arm connected to the second rotating shaft; a third shaft assembly including a third rotating shaft and a third shaft motor for driving the third rotating shaft, the third rotating shaft being provided at an end of the second connecting arm away from the second rotating shaft; and a bearing portion connected with the third shaft assembly and configured to carry a shooting equipment. An axial direction of the second rotating shaft may be perpendicular to an extending direction of the second connecting arm. When the handheld gimbal is in a usage state, one or more of the first shaft motor, the second shaft motor, and the third shaft motor may be configured to provide driving force to adjust spatial position of the bearing portion. When the handheld gimbal is changed from the usage state to a storage state to a folded state, the second shaft motor may be configured to provide driving force to rotate the second connecting arm to fold the handheld gimbal, and both the first rotating shaft and the third rotating shaft may be located on a same side of the second rotating shaft after the handheld gimbal is folded.

### BRIEF DESCRIPTION OF THE DRAWINGS

In order to explain technical features of embodiments of the present disclosure more clearly, drawings used in the present disclosure are briefly introduced as follow. Obviously, the drawings in the following description are some exemplary embodiments of the present disclosure. Ordinary person skilled in the art may obtain other drawings and features based on these disclosed drawings without creative work.

FIG. 1 shows a schematic structural diagram of a handheld gimbal in a usage state according to an embodiment of the present disclosure;

FIG. 2 shows a schematic diagram of a partial structure of a handheld gimbal according to an embodiment of the present disclosure;

FIG. 3 shows a schematic structural diagram of a handheld gimbal in a usage state according to an embodiment of the present disclosure;

FIG. 4 shows a schematic structural diagram of a handheld gimbal in a folded state according to an embodiment of the present disclosure;

FIG. 5 shows a schematic structural diagram of a handheld gimbal in a folded state according to an embodiment of the present disclosure;

FIG. 6 shows a schematic structural diagram of a handheld gimbal in a folded state according to an embodiment of the present disclosure;

FIG. 7 shows a schematic structural diagram of a handheld gimbal in a folded state according to an embodiment of the present disclosure;

FIG. 8 shows a schematic structural diagram of a handheld gimbal in a folded state according to an embodiment of the present disclosure;

FIG. 9 shows a schematic structural diagram of a handheld gimbal in a folded state according to an embodiment of the present disclosure.

### DETAILED DESCRIPTION

In order to make objectives, technical solutions, and advantages of embodiments of the present disclosure clearer, the technical solutions in the embodiments of the present disclosure will be described clearly and completely in conjunction with the accompanying drawings in the embodiments of the present disclosure. Obviously, the described embodiments are part of the embodiments of the present disclosure, rather than all of the embodiments. Based on the embodiments of the present disclosure, all other embodiments obtained by those of ordinary skill in the art without creative work shall fall within protection scope of the present disclosure. In the case of no conflict, the following embodiments and features in the embodiments may be recombined with one another.

In the following description, many specific details are set forth in order to fully understand this disclosure. However, this disclosure can also be implemented in other ways different from those described here. Therefore, the protection scope of the present disclosure is not limited by the specific embodiments disclosed below.

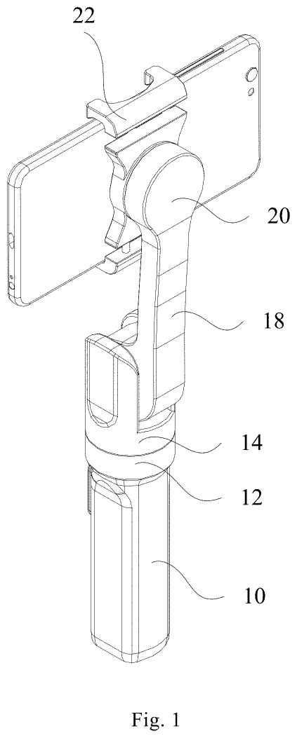

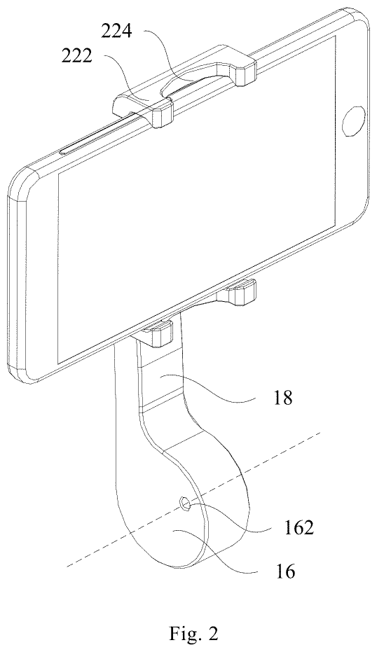

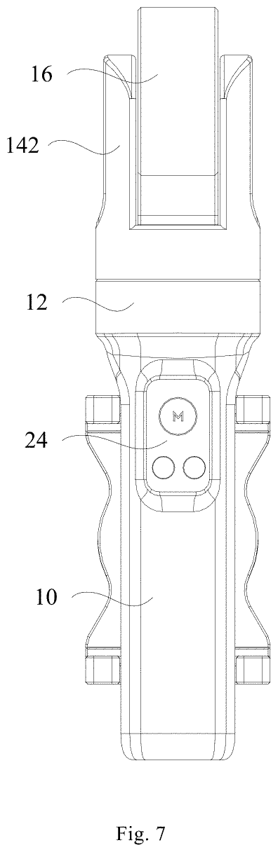

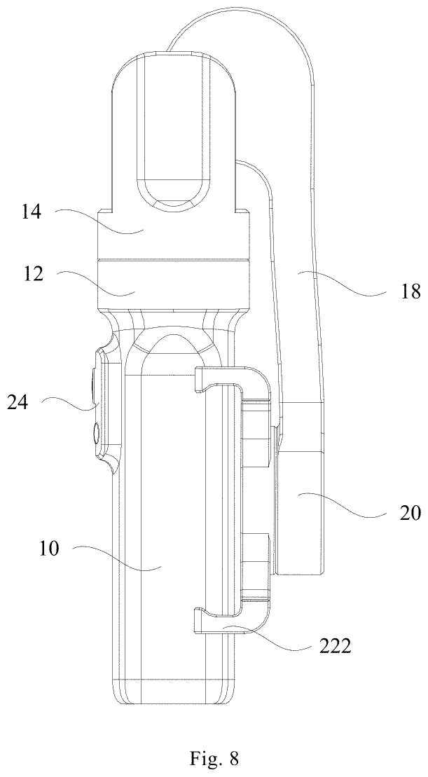

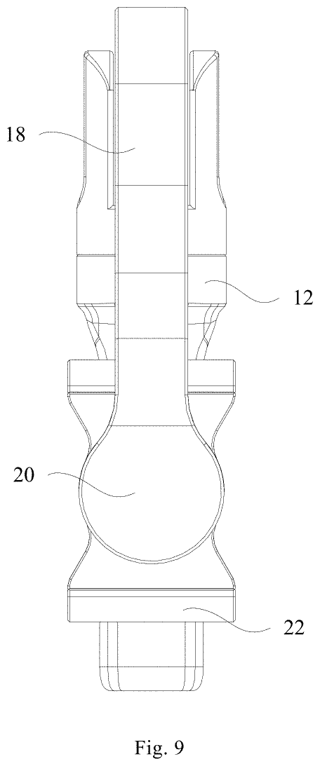

Hereinafter, the handheld gimbal according to some embodiments of the present disclosure will be described with reference to FIGS. 1-9. Wherein, the dash line in FIG. 2 represents schematically a rotating axis of the second rotating shaft 16.

As shown in FIGS. 1-5, one embodiment of the present disclosure provides a handheld gimbal. The handheld gimbal includes a handle 10 with a top, a bottom and a side wall between the top and the bottom; a first shaft assembly including a first rotating shaft 12 provided at a top of the handle 10, a first shaft motor (not shown in the figure) for driving the first rotating shaft 12, and a first connecting arm 14 connected to the first rotating shaft 12; a second shaft assembly including a second rotating shaft 16, a second shaft motor (not shown in the figure) for driving the second rotating shaft 16, and a second connecting arm 18 connected with the second rotating shaft 16; a third shaft assembly including a third rotating shaft 20 and a third shaft motor (not shown in the figure) for driving the third rotating shaft 20; and a bearing portion 22 connected with the third shaft assembly for, for example, carrying a shooting equipment. An axial direction of the second rotating shaft 16 is perpendicular to an extending direction of the second connecting arm 18. The axial direction of a rotating shaft refers to a direction of a rotating axis around which the rotating shaft rotates. The third rotating shaft 20 is provided at an end of the second connecting arm 18 away from the second shaft 16. When the handheld gimbal is in use, any one or more of the first shaft motor, the second shaft motor and the third shaft motor may provide driving force to adjust spatial position of the bearing portion. When the handheld gimbal is changed from a usage state to a storage or folded state, the second shaft motor provides driving force to rotate the second connecting arm 18 to fold the handheld gimbal. After folding, the first rotating shaft 12 and the third rotating shaft 20 are both located on the same side of the rotating axis of the second rotating shaft 16.

This embodiment of the present disclosure provides a three-shaft handheld gimbal, which can realize pitch movement of the second connecting arm 18 controlled by the second shaft motor in the non-usage state so as to realize folding of the handheld gimbal. This configuration may save space for holding the handheld gimbal when the handheld gimbal is not in use. When it is required to use the handheld gimbal, the second connecting arm 18 is controlled to rotate to open the handheld gimbal through the second shaft motor, and the three-shaft handheld gimbal can be used normally. This configuration can realize the folding of the handheld gimbal in the non-usage state while realizing function of rotating the handheld gimbal around three axes. Because the tilt shaft is reused for the gimbal folding, there is no need to add unnecessary folding shafts to assist the rotation of the handheld gimbal. It can also enhance overall stability of the handheld gimbal and eliminate influence of non-essential factors on the stability of the handheld gimbal, thereby facilitating carrying of the handheld gimbal, reducing the space required for storing the handheld gimbal, and facilitating storage.

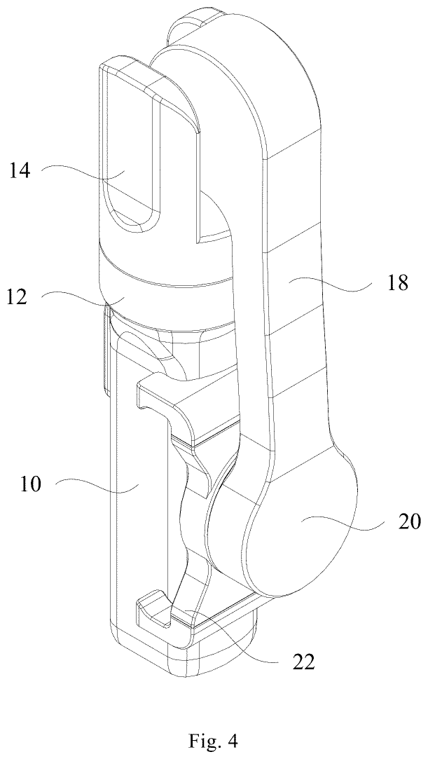

Optionally, the handheld gimbal includes a handle 10, a first rotating shaft 12, a second rotating shaft 16 and a third rotating shaft 20, wherein the axial direction of the second rotating shaft 16 is perpendicular to the extending direction of the second connecting arm 18. That is, the second connecting arm 18 is capable of pitching movement. When the handheld gimbal is in use, it can provide driving force through any one or more of the first shaft motor, the second shaft motor and the third shaft motor to adjust spatial position of the bearing portion. The position of the bearing portion in the space can be adjusted accurately, and the stability of the shooting equipment such as mobile phones and cameras placed on the bearing portion can be increased. When the handheld gimbal is changed from the usage state to the storage state as shown in FIGS. 4 to 9, the second shaft motor can be used to provide power to rotate the second connecting arm so as to achieve the folding of the handheld gimbal. The folded first shaft 12 and the third shaft 20 are both located on the same side of the rotating axis of the second rotating shaft 16, for example, on the side of the rotating axis of the second rotating shaft 16 toward the handle 10. As such, folding the handheld gimbal through the usage of the second rotating shaft 16 is realized, so that the first rotating shaft 12 and the third rotating shaft 20 disposed at both ends of the second rotating shaft 16 can be close to each other, thereby realizing half-folding or nearly half-folding of the handheld gimbal. As such, it is convenient to carry and store the handheld gimbal.

Optionally, the first shaft motor can drive the first rotating shaft 12 as a whole or partially to rotate to drive the first connecting arm 14 to rotate. The second shaft motor can drive the second rotating shaft 16 as a whole or partially to rotate to drive the second connecting arm 18 to rotate. The third shaft motor can drive the third rotating shaft 20 as a whole or partially to rotate to drive the bearing portion 22 to rotate.

In some embodiments, the first rotating shaft 12 includes a first housing fixedly connected to the handle and a first shaft arranged in the first housing. The first shaft motor drives the first shaft to rotate to drive the first connecting arm to rotate. At this time, the first shaft motor drives the first rotating shaft 12 partially to rotate.

In other embodiments, the first rotating shaft 12 is fixedly connected or movably connected to the first connecting arm 14, and the first shaft motor directly drives the first rotating shaft 12 to rotate to drive the first connecting arm to rotate. At this time, the first shaft motor drives the first rotating shaft 12 as a whole to rotate.

In some embodiments, the third rotating shaft 20 includes a third housing fixedly connected to the second connecting arm 18 and a third shaft provided in the third housing. The third shaft motor drives the third shaft to rotate to drive the bearing portion 22 to rotate. At this time, the third shaft motor drives the third rotating shaft 20 partially to rotate.

In other embodiments, the third rotating shaft 20 is movably connected to the second connecting arm 18, and the third shaft motor directly drives the third rotating shaft 20 to rotate so as to drive the bearing portion 22 to rotate. At this time, the third shaft motor drives the third rotating shaft 20 as a whole to rotate.

In some embodiments, the second connecting arm 18 and the second rotating shaft 16 are integrally formed. At this time, the second shaft motor can drive the second rotating shaft 16 as a whole to rotate.

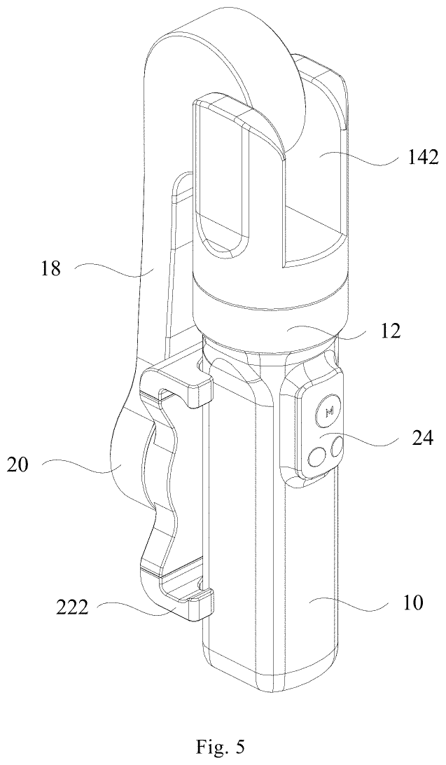

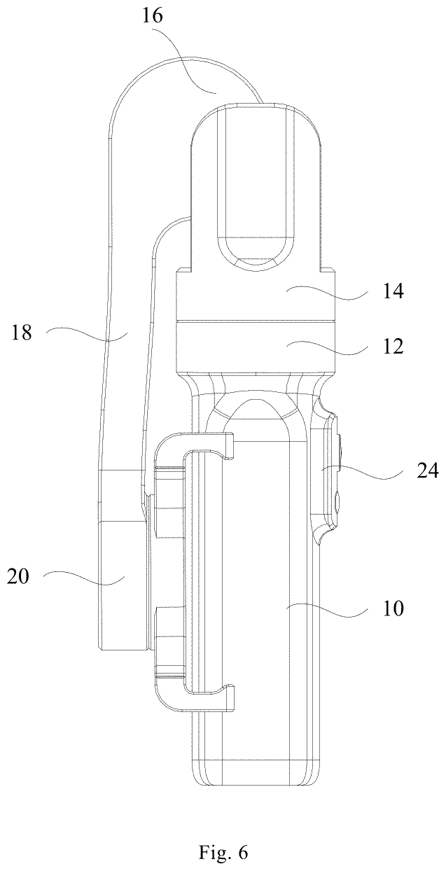

In some embodiments, as shown in FIGS. 5 and 6, when the handheld gimbal is changed from the usage state to the storage state, after the folding of the handheld gimbal, the bearing portion 22 is located between the second connecting arm 18 and the side wall of the handle 10 thereby improving storage effect of the handheld gimbal.

In some embodiments, when the handheld gimbal is changed from the usage state to the storage state, after the folding of the handheld gimbal, the bearing portion 22 is located on the side of the second connecting arm 18 away from the handle 10. That is, the second connecting arm 18 is located between the bearing portion 22 and the handle 10. Such design can avoid the situation in which it is difficult to sandwich the bearing portion 22 between the second connecting arm 18 and the handle 10 due to the large volume of the bearing portion 22. Moreover, it is beneficial to fold the shooting equipment placed on the bearing portion 22 together with the bearing portion 22 on the side of the second connecting arm 18 away from the handle 10, which facilitates the folding of the handheld gimbal in the non-usage state during shooting without disassembling the shooting equipment.

In some embodiments, the bearing portion 22 is provided with a buckling portion, and the buckling portion can be buckled with the handle 10 when the handheld gimbal is changed from the usage state to the storage state. This is helpful for the handheld gimbal to maintain the folded state stably.

In some embodiments, as shown in FIGS. 2 and 5, the buckling portion includes an avoidance groove 224, and the avoidance groove can at least partially cover the handle 10 so as to buckle with the handle 10. On one hand, it is beneficial to avoid the handle 10 and avoid collision between the bearing portion 22 and the handle 10 after folding. On the other hand, it is helpful for the handheld gimbal to be folded in place, so that the bearing portion 22 can at least partially overlap the handle 10, thereby reducing the folded volume of the handheld gimbal and facilitating carrying and storage of the handheld gimbal.

In some embodiments, the bearing portion 22 includes a damper or a clamping mechanism, which is conducive to stably clamping the shooting equipment. Of course, the bearing portion 22 may not include a clamper or a clamping mechanism, and the shooting equipment can be directly placed on the position defined by the bearing portion 22.

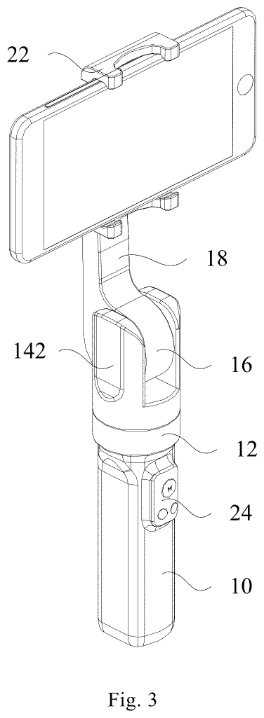

In some embodiments, as shown in FIGS. 2 and 3, the clamping mechanism includes a main body and two clamping ears 222 oppositely distributed at two ends of the main body. The two clamping ears 222 can move relatively against each other. The two relatively movable clamping ears 222 can clamp the shooting equipment, which is beneficial to clamp shooting equipment of different sizes, and improves clamping stability and versatility of the clamping mechanism.

In some embodiments, as shown in FIGS. 4 to 6, when the handheld gimbal is changed from the usage state to the storage state, the two clamping ears 222 are spaced apart along a direction parallel to the length direction of the handle 10 or perpendicular to the length direction of the handle 10.

In this embodiment, when the handheld gimbal is changed from the usage state to the folded state, if the two clamping ears 222 are spaced apart along the length direction of the handle 10, it is helpful for the handheld gimbal to stably hold the shooting equipment in the usage state and avoid the shooting equipment being dropped. If the two clamping ears 222 are spaced apart in a direction perpendicular to the length direction of the handle 10, it is beneficial to avoid the handle 10 after folding.

In some embodiments, the first shaft motor can drive the first connecting arm 14 to make a yaw movement relative to the handle 10, thereby realizing automatic yaw motion function of the handheld gimbal.

In some embodiments, the second shaft motor can drive the second connecting arm 18 to make a pitch movement relative to the first connecting arm 14, thereby realizing automatic pitch motion function of the handheld gimbal.

In some embodiments, the third shaft motor can drive the bearing portion 22 to roll, thereby realizing automatic roll motion function of the handheld gimbal.

In some embodiments, the rotating axis of the first rotating shaft and the rotating axis of the second rotating shaft intersect perpendicularly in the first projection plane, and the rotating axis of the second rotating shaft and the rotating axis of the third rotating shaft intersect perpendicularly in the second projection plane. Wherein, the first projection plane is a projection plane in a side view direction of the handheld gimbal, and the second projection plane is a projection plane in a top view direction of the handheld gimbal. Such configuration is helpful for the handheld gimbal to realize yaw, pitch and roll movements, thereby realizing multi-angle movement of the bear portion in the space.

Optionally, the first projection plane is any projection plane in the side view direction of the handheld gimbal. Even if the rotating axis of the second rotating shaft projects as only one point in a projection plane of a certain angle, it is determined that the rotating axis of the first rotating shaft and the rotating axis of the second rotating shaft intersect perpendicularly within the projection plane. Similarly, the second projection plane is any projection plane in the top view direction of the handheld gimbal. Even if the rotating axis of the third rotating shaft projects as only one point when the handheld gimbal is in a certain posture, it is also determined that the rotating axis of the second rotating shaft and the rotating axis of the third rotating shaft intersect perpendicularly within the projection plane.

It should be noted that, in this disclosure, the direction viewed from the top to the bottom of the handle 10 is the top view direction of the handheld gimbal, and the direction of looking squarely at the side wall of the handle 10 is the side view direction of the handheld gimbal.

In some embodiments, when the handheld gimbal is in use, the second rotating shaft is closer to the handle 10 than the third rotating shaft. When the handheld gimbal is changed from the usage state to the storage state, after the folding of the handheld gimbal, the third rotating shaft is closer to the handle 10 than the second rotating shaft.

In this embodiment, since the handle 10, the first shaft motor, the second shaft motor, and the third shaft motor are connected in sequence, the middle connecting parts between the shaft motors such as the first connecting arm 14, the second connecting arm 18 and so on are omitted here. By setting that, when the handheld gimbal is in use, the second rotating shaft 16 is closer to the handle 10 than the third rotating shaft 20, that is, the third rotating shaft 20 is farther away from the handle 10, it is advantageous for the bearing portion 22 located at the free end to extend to a larger and farther space. By setting that, when the handheld gimbal is changed from the usage state to the storage state, the third rotating shaft 20 is closer to the handle 10 than the second rotating shaft 16 after folding, it is beneficial to reduce occupied space of the handheld gimbal after the folding, and is convenient for storage and portability.

Optionally, when the handheld gimbal is changed from the usage state to the storage state, after folding, the third rotating shaft 20 is close to the side wall or bottom of the handle 10, and the second rotating shaft 16 and the handle 10 are still separated at least by the first rotating shaft 12.

In some embodiments, when the handheld gimbal is in use, the third rotating shaft 20 is located at the top area of the handle 10. When the handheld gimbal is changed from the usage state to the storage state, after folding, the third rotating shaft 20 is close to the side wall of the handle 10 and located at one side of the handle 10, or the third rotating shaft 20 is located at the bottom area of the handle 10 after the folding.

Among them, the third rotating shaft being located at the top area of the handle 10 means that the third rotating shaft 20 extends beyond the top of the handle 10 in the length direction of the handle 10. The third rotating shaft protruding slightly beyond the top of the handle 10 is also considered as extending beyond the top of the handle. The third rotating shaft being located at the bottom area of the handle 10 means that the third rotating shaft extends beyond the bottom of the handle 10 in the length direction of the handle 10. The third rotating shaft 20 protruding slightly beyond the bottom of the handle 10 is also considered as extending beyond the bottom of the handle as well.

Optionally, when the folded third rotating shaft is located at the bottom area of the handle 10, the length of the second connecting arm 18 is longer than the handle 10, and further, the second connecting arm 18 is an L-shaped arm or a [symbol] -shaped arm.

In some embodiments, as shown in FIG. 1, the second rotating shaft 16 is connected to an end of the first connecting arm 14 away from the first rotating shaft 12. Optionally, the rotating axis of the second rotating shaft 16 is perpendicular to the extending direction of the first connecting arm 14. This configuration is convenient for the second connecting arm 18 to perform pitch motion relative to the first connecting arm 14.

In some embodiments, as shown in FIGS. 3 and 5, the first connecting arm 14 includes two connecting ears 142 at one end thereof, and the second rotating shaft 16 partially extends into a space between the two connecting ears 142 and is rotatably connected to the two connecting ears 142.

In this embodiment, by setting the first connecting arm 14 including two connecting ears 142 distributed at intervals, and the second rotating shaft 16 being partially extended into a space between the two connecting ears 142 and rotatably connected with the two connecting ears 142, the rotation connection with the first connecting arm 14 is realized. The connection is stable and reliable, and the space between the two connecting ears 142 also provides an avoidance space for the pitch movement of the second connecting arm 18.

Optionally, as shown in FIG. 2, the second rotating shaft 16 is provided with a through hole 162 for inserting the rotating shaft, and the rotating shaft is inserted into the through hole 162 and extends into the two connecting ears 142.

In some embodiments, the first connecting arm 14 is disposed at the top of the first rotating shaft 12, and the rotating center line of the first connecting arm 14 overlaps with the rotating axis of the first rotating shaft 12.

Optionally, as shown in FIG. 3, the first connecting arm 14 has a columnar structure, and the first rotating shaft 12 also has a columnar structure, and the outer diameters of the two are substantially the same.

In some embodiments, as shown in FIG. 2, the rotating axis of the second rotating shaft 16 deviates from the area covered by the second connecting arm 18 in its length direction. That is, in a top view direction, the second connecting arm 18 does not overlap the rotating axis of the second rotating shaft 16. This is beneficial for the second connecting arm 18 to be closer to the handle 10 and in a tightened state after being folded, which reduces the space occupied by the handheld gimbal after the folding and facilitates carrying of the handheld gimbal.

In some embodiments, as shown in FIG. 2, the rotating axis of the second rotating shaft 16 deviates from its own center line. That is, the rotating axis of the second rotating shaft intersects with a surface of the second rotating shaft at a point deviating from a center of the second rotating shaft. This is advantageous for the second connecting arm 18 to be closer to the handle 10 after the folding.

In some embodiments, the second connecting arm 18 extends along the tangential direction of the second rotating shaft 16.

Optionally, as shown in FIG. 2, the second connecting arm 18 and the second rotating shaft 16 are distributed in a b-shape. At this time, the second connecting arm 18 and the second rotating shaft 16 are distributed substantially in a b-shape.

Optionally, the rotating axis of the second rotating shaft 16 overlaps with its own center line, That is, the rotating axis of the second rotating shaft intersects with a surface of the second rotating shaft at a center of the second rotating shaft. Optionally the second connecting arm 18 is configured as an L-shaped arm. At this time, it is sufficient that the second connecting arm 18 is substantially L-shaped, which is advantageous for the long arm part of the second connecting arm 18 to be close to the handle 10 after folding.

In some embodiments, the axial direction of the first rotating shaft 12, the axial direction of the second rotating shaft 16 and the axial direction of the third rotating shaft 20 are perpendicular to one another in pairs.

In some embodiments, the extending direction of the first connecting arm is aligned with the axial direction of the first rotating shaft. During the yaw movement of the first connecting arm, the center of gravity of the first connecting arm can completely fall on the first rotating shaft, or even on the rotating axis of the first rotating shaft, so as to ensure operating stability of the handheld gimbal.

In some embodiments, as shown in FIG. 5, the handheld gimbal further includes: a control panel 24, which is arranged on the side wall of the handle 10. When the handheld gimbal is changed from the usage state to the storage state, the folded second connecting arm 18 can be located on a side of the handle 10 away from the control panel 24. This can effectively prevent the second connecting arm 18 from blocking the control panel 24, which facilitates the user to operate the control panel 24 and prevents the second connecting arm 18 from touching the control panel 24 during the pitch motion to cause error operation.

Optionally, taking the direction of the control panel 24 as the front of the handle 10, the second connecting arm 18 can perform a pitch movement backward, or it can perform a pitch movement forward and/or a pitch movement backward.

In some embodiments, the handheld gimbal further includes a battery (not shown in the figure), which is arranged inside the handle 10.

Hereinafter, referring to FIGS. 1 to 9, the handheld gimbal according to one embodiment of the present disclosure will be described in detail.

As shown in FIGS. 1 to 3, the handheld gimbal includes a handle 10, a first rotating shaft 12, a first connecting arm 14, a second rotating shaft 16, a second connecting arm 18, a third rotating shaft 20, and a clamping mechanism (the bearing portion 22 includes the clamping mechanism). The second connecting arm 18 can be driven by the second shaft motor to drive the third rotating shaft 20 and the bearing portion 22 to pitch together with respect to the handle 10, so as to realize the folding of the handheld gimbal. The three-shaft handheld gimbal is folded with the second rotating shaft 16 as the boundary, which is convenient for carrying and storing the handheld gimbal.

Optionally, the specific folding step is that the second shaft motor controls the rotation of the second rotating shaft 16 so that the second connecting arm 18 performs a top view or pitch movement until it moves to one side of the handle 10. As shown in FIGS. 4 to 9, when the control panel 24 is provided on the handle 10, the second connecting arm 18 is specifically controlled to move in a top view or pitch direction away from the control panel 24. In the case where an avoidance groove 224 is provided on the clamping ears 222 of the clamping mechanism, the second connecting arm 18 is specifically controlled to move until the avoidance groove 224 is buckled with the handle 10. When changing from the storage state to the usage state, the second shaft motor controls the rotation of the second rotating shaft 16 so that the second connecting arm 18 performs a top view movement. After the folded state is released, the first connecting arm 14 is controlled to perform yaw movement or the bearing portion 22 is controlled to perform a roll motion.

In this disclosure, the term “plurality” refers to two or more than two, unless specifically defined otherwise. The terms “installed,” “connected,” “fixed” and other terms should be understood in a broad sense. For example, “connected” can be a fixed connection, a detachable connection, or an integral connection; “connected” can be directly connected or indirectly connected through an intermediary. For those of ordinary skill in the art, the specific meanings of the above-mentioned terms in this disclosure can be understood according to specific circumstances.

In the description of this specification, the description of the terms “one embodiment,” “some embodiments,” “specific embodiments,” etc. means that the specific features, structures, materials, or characteristics described in conjunction with the embodiments or examples are included in at least one embodiment or example. In this specification, the schematic representations of the above-mentioned terms do not necessarily refer to the same embodiment or example. Moreover, the described specific features, structures, materials or characteristics in any one or more embodiments or examples can be recombined in a suitable manner.

The foregoing descriptions are only preferred embodiments of the disclosure, and are not intended to limit the disclosure. For those skilled in the art, the disclosure can have various modifications and changes. Any modification, equivalent replacement, improvement, etc. made within the spirit and principle of this disclosure shall be included in the protection scope of this disclosure.

What is claimed is:

1. A handheld gimbal, comprising
a handle having a top, a bottom, and a side wall between the top and the bottom;
a first shaft assembly including a first rotating shaft provided at the top of the handle, a first shaft motor for driving the first rotating shaft, and a first connecting arm connected with the first rotating shaft;
a second shaft assembly including a second rotating shaft, a second shaft motor for driving the second rotating shaft, and a second connecting arm connected to the second rotating shaft;
a third shaft assembly including a third rotating shaft and a third shaft motor for driving the third rotating shaft, the third rotating shaft being provided at an end of the second connecting arm away from the second rotating shaft; and
a bearing portion connected with the third shaft assembly and configured to carry a shooting equipment,
wherein an axial direction of the second rotating shaft is perpendicular to an extending direction of the second connecting arm;
in a usage state of the handheld gimbal, one or more of the first shaft motor, the second shaft motor, and the third shaft motor are configured to provide driving force to adjust spatial position of the bearing portion; and
in a storage state of the handheld gimbal, the second shaft motor is configured to provide driving force to rotate the second connecting arm to fold the handheld gimbal, and both the first rotating shaft and the third rotating shaft are located on a same side of the second rotating shaft after the handheld gimbal is folded.

2. The handheld gimbal according to claim 1, wherein, in the storage state of the handheld gimbal, the bearing portion is located between the second connecting arm and the side wall of the handle in a direction perpendicular to a length direction of the handle after the handheld gimbal is folded.

3. The handheld gimbal according to claim 1, wherein, in the storage state of the handheld gimbal, the bearing portion is located on a side of the second connecting arm away from the handle in a direction perpendicular to a length direction of the handle after the handheld gimbal is folded.

4. The handheld gimbal according to claim 2, wherein the bearing portion comprises a buckling portion, and in the storage state of the handheld gimbal, the buckling portion is configured to be buckled with the handle.

5. The handheld gimbal according to claim 4, wherein the buckling portion includes an avoidance groove, and the avoidance groove is configured to cover the handle at least partially so as to buckle with the handle.

6. The handheld gimbal according to claim 1, wherein the bearing portion comprises a clamper.

7. The handheld gimbal according to claim 6, wherein the clamper includes a main body and two clamping ears which are relatively distributed at two ends of the main body, and the two clamping ears are configured to be able to move relatively against each other.

8. The handheld gimbal according to claim 7, wherein in the storage state of the handheld gimbal, the two clamping ears are spaced apart along a length direction of the handle or spaced apart in a direction perpendicular to the length direction of the handle.

9. The handheld gimbal according to claim 1, wherein the first shaft motor is configured to drive the first connecting arm to make a yaw motion relative to the handle;
the second shaft motor is configured to drive the second connecting arm to make a pitch motion relative to the first connecting arm; and
the third shaft motor is configured to drive the bearing portion to roll.

10. The handheld gimbal according to claim 9, wherein a rotating axis of the first rotating shaft and a rotating axis of the second rotating shaft intersect perpendicularly in a first projection plane, and the rotating axis of the second rotating shaft and a rotating axis of the third rotating shaft intersect perpendicularly in a second projection plane, wherein the first projection plane is a projection plane in a side view direction of the handheld gimbal, and the second projection plane is a projection plane in a top view direction of the handheld gimbal;
in the usage state of the handheld gimbal, the second rotating shaft is closer to the handle than the third rotating shaft; and
in the storage state of the handheld gimbal, the third rotating shaft is closer to the handle than the second rotating shaft after the handheld gimbal is folded.

11. The handheld gimbal according to claim 10, wherein
in the usage state of the handheld gimbal, the third rotating shaft is located at a top area of the handle; and
in the storage state of the handheld gimbal, after the handheld gimbal is folded, the third rotating shaft is close to the side wall of the handle and located on one side of the handle, or the third rotating shaft is located at a bottom area of the handle.

12. The handheld gimbal according to claim 1, wherein the second rotating shaft is connected to an end of the first connecting arm away from the first rotating shaft, and a rotating axis of the second rotating shaft is perpendicular to an extending direction of the first connecting arm.

13. The handheld gimbal according to claim 1, wherein the first connecting arm includes two connecting ears at one end of the first connecting arm, and the second rotating shaft partially extends into a space between the two connecting ears and is rotatably connected with the two connecting ears.

14. The handheld gimbal according to claim 1, wherein the first connecting arm is arranged at the top of the first rotating shaft, and a rotating center line of the first connecting arm overlaps a rotating axis of the first rotating shaft.

15. The handheld gimbal according to claim 1, wherein a rotating axis of the second rotating shaft deviates from an area covered by the second connecting arm in its length direction.

16. The handheld gimbal according to claim 15, wherein the rotating axis of the second rotating shaft deviates from its own center line.

17. The handheld gimbal according to claim 15, wherein the second connecting arm extends along a tangential direction of the second rotating shaft, and the second connecting arm and the second rotating shaft are configured to be distributed substantially in a b-shape.

18. The handheld gimbal according to claim 15, wherein the rotating axis of the second rotating shaft overlaps with its own center line, and the second connecting arm is configured substantially as an L-shaped arm.

19. The handheld gimbal according to claim 1, wherein an axial direction of the first rotating shaft, the axial direction of the second rotating shaft, and an axial direction of the third rotating shaft are perpendicular to one another in pairs, and an extending direction of the first connecting arm is aligned with the axial direction of the first rotating shaft.

20. The handheld gimbal according to claim 1, further comprising:
a control panel arranged on the side wall of the handle;
wherein in the storage state of the handheld gimbal, the second connecting arm is located on a side of the handle away from the control panel after the handheld gimbal is folded.
